(19) United States
(12) Patent Application Publication
(10) Pub. No.: US 2018/0334323 A1
(43) Pub. Date: Nov. 22, 2018

(54) Garbage, Trash And Waste Storage Device

(71) Applicant: Adam Douglas Everard, Manitowoc, WI (US)

(72) Inventor: Adam Douglas Everard, Manitowoc, WI (US)

(21) Appl. No.: 15/982,074

(22) Filed: May 17, 2018

Related U.S. Application Data
(60) Provisional application No. 62/508,981, filed on May 19, 2017.

(51) Int. Cl. B65F 1/02; B65F 1/16

(52) U.S. Cl. CPC B65F 1/02; B65F 1/16; B65F 2210/137; B65F 2210/13; B65F 2210/116

(57) ABSTRACT

The present invention provides, among other things, a garbage, trash, and waste storage container including a heat exchanger operable to reduce the temperature of garbage, trash, and waste located in an interior of the container in order to reduce or eliminate odor causing bacteria from the garbage, trash, and waste. In some embodiments, the container includes a controller. In some such embodiments, the controller operates the heat exchanger to reduce an interior container temperature and to maintain the temperature of the interior of the container below a pre-determined temperature. In some embodiments, the garbage, trash, and waste storage device generates cold air inside of the garbage, trash, and waste storage device with at least one cooling mechanism that is powered by an electrical cord and plug that is plugged into an electrical wall socket. The garbage, trash, and waste storage device is designed to cool the garbage, trash, and waste while the garbage, trash, and waste is inside the garbage, trash, and waste storage device.

### FIELD OF THE INVENTION

The present invention referencing application number 62508981 relates generally to garbage, trash and waste odor reduction and storage. More specifically, the present invention provides a container operable to reduce or eliminate bacteria from garbage or other trash or waste.

### BRIEF SUMMARY OF THE PRESENT INVENTION

The present invention provides, among other things, a garbage, trash and waste storage container including a heat exchanger operable to reduce the temperature of garbage and trash located in an interior of the container in order to reduce or eliminate odor causing bacteria from the garbage, trash and waste as well as to reduce or eliminate foreign bodies and hosts from entering the storage container. In some embodiments, the container includes a controller. In some such embodiments, the controller operates the heat exchanger to reduce an interior container temperature and to maintain the temperature of the interior of the container below a pre-determined temperature.

In some embodiments, the garbage storage device generates cold air inside of the garbage storage device with at least one cooling mechanism that is powered by an electrical cord and plug that is plugged into an electrical wall socket. The garbage storage device is designed to cool the garbage while the garbage is inside the garbage storage device. In some embodiments, the device can be utilized for any garbage or trash item including: food, paper, plastic, metal, liquid, synthetic substances, etc.

In some embodiments, the heat exchanger of the present invention is electrically powered. In some such embodiments, the controller or the heat exchanger receives electrical power from batteries.

Some embodiments of the invention include an exterior shell, an interior shell and insulation housed between the exterior shell and the interior shell in order to retain the cooled air that is generated by the cooling mechanism. Charcoal can be embedded in the insulation in order to reduce odors while the garbage is inside the garbage storage device. A noise reduction lining can be positioned between the exterior shell and the interior shell. A lid can be rotatably coupled to the exterior shell to allow the user to open, close, and access the interior of the garbage storage device.

In some embodiments, removable devices, such as fasteners or hanging rods, can be positioned inside the garbage storage device to hang garbage inside the garbage storage device. A removable bag can be coupled to the fasteners or hanging rods to contain the garbage while the garbage is inside the garbage storage device.

In some embodiments, a cooling unit, such as cooling plates, can be utilized to reduce the temperature inside the garbage storage unit below a desired temperature. A control panel can allow the user to vary the temperature within the garbage storage device, turn the device on or off manually, and or to set a timer to turn the device on or off automatically. The cooling unit can include cooling fans to help reduce the temperature of the cooling plates. A noise reduction lining can extend around the cooling unit. Rubber seals and flanges can be included to retain the cool air inside the garbage storage device.

In some embodiments, a rotation device, such as a rotating drum or stirring rod, can be positioned within the interior shell of the garbage storage device to rotate within the garbage storage device.

In some embodiments, a circuit board and microprocessor can be linked to the control panel, with integrated software, which enable the user to vary the temperature inside the garbage storage device and to program the garbage storage device to turn on and off automatically and to enter the garbage storage device into timed freezing cycles. A power supply, relay, Arduino hardware, and power cord can be used to power the cooling device mechanisms, control panel, circuit board, microprocessor and cooling fans.

Some embodiments of the present invention include a garbage storage device that reduces the temperature inside the garbage storage device below a set temperature. The device includes an exterior shell, an interior shell, insulation with embedded charcoal positioned between the exterior and interior shell, noise reduction lining positioned between the exterior and interior of the garbage storage device and a top coupled to the garbage storage device. A cooling mechanism can include cooling plates, and a noise reduction lining positioned around the cooling plates.

One or more hangers, such as protrusions, rods, hooks and the like can be positioned inside the garbage storage device to hang items from while the garbage is inside the storage device. A removable bag can be coupled to the hangers to support a bag that houses the garbage inside the storage device. A rotating drum and/or stir rod can be positioned within the interior shell of the garbage storage device to rotate or stir the garbage in the storage device.

A control panel, a circuit panel, a micro-processor with integrated software can be integrated into the garbage storage device. A user can control the cooling mechanism by varying the temperatures of the interior of the garbage storage device, manually turning the cooling mechanism off and on, and or setting the cooling mechanism on a timer in order to turn off or on.

### BRIEF DESCRIPTION OF THE SEVERAL VIEWS OF THE DRAWINGS

FIG. 1.0 is a perspective view, showing the container according to some embodiments of the present invention.

FIG. 1.1 is a perspective view, showing the lid of the container according to some embodiments of the invention.

FIG. 2.0 is an exploded perspective view, showing the exterior shell separated from the interior shell.

FIG. 2.1 is an exploded perspective view, showing the exterior lid shell separated from the interior lid shell.

FIG. 3.0 is a schematic view, showing the separate components according to some embodiments of the invention.

FIG. 4.0 is a schematic view, showing the interior of the container according to some embodiments of the invention.

FIG. 5.0 is a schematic view, showing the interior of the container according to some embodiments of the invention.

FIG. 6.0 is a schematic view, showing the interior of the container according to some embodiments of the invention.

FIG. 7.0 is a schematic view, showing the interior of the container according to some embodiments of the invention.

FIG. 8.0 is an exploded perspective view, according to some embodiments of the invention.

FIG. 9.0 is a cross-sectional view according to some embodiments of the invention.

FIG. 10.0 is a cross-sectional view according to some embodiments of the invention.

FIG. 11.0 is a cross-sectional view according to some embodiments of the invention.

FIG. 12.0 is a perspective view, showing the circuit board according to some embodiments of the invention.

FIG. 13.0 is a schematic view, showing the exterior lid according to some embodiments of the invention.

FIG. 14.0 is a perspective view according to some embodiments of the invention.

FIG. 15.0 is a perspective view according to some embodiments of the invention.

### REFERENCE NUMERALS IN THE DRAWINGS

10. Exterior shell
11. Interior shell
12. Insulation with embedded charcoal
13. Noise reduction film tape
14. Exterior lid shell
15. Lid insulation with embedded charcoal
16. Interior lid shell
17. Removable hanging devices
18. Removable mesh netting bag
19. Removable bag/sack
20. Cooling plates
21. Cooling devices
22. Control panel
23. Stir rod
24. Electrical cord and plug
25. Hinge
26. Base
27. Handle
28. Cooling fan
29. Power supply
30. Relay
31. Arduino hardware
32. Cover flange
33. Base flange
34. Seal
35. Circuit board
36. Microprocessor

### DETAILED DESCRIPTION OF THE INVENTION

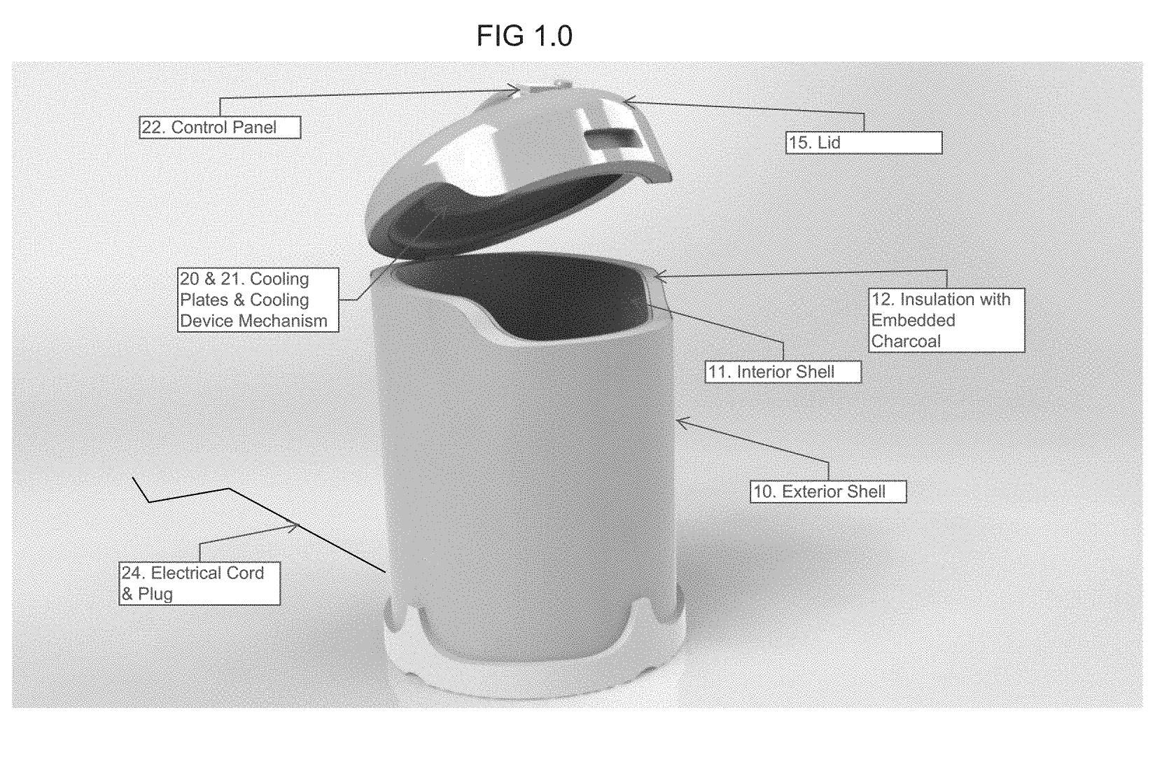

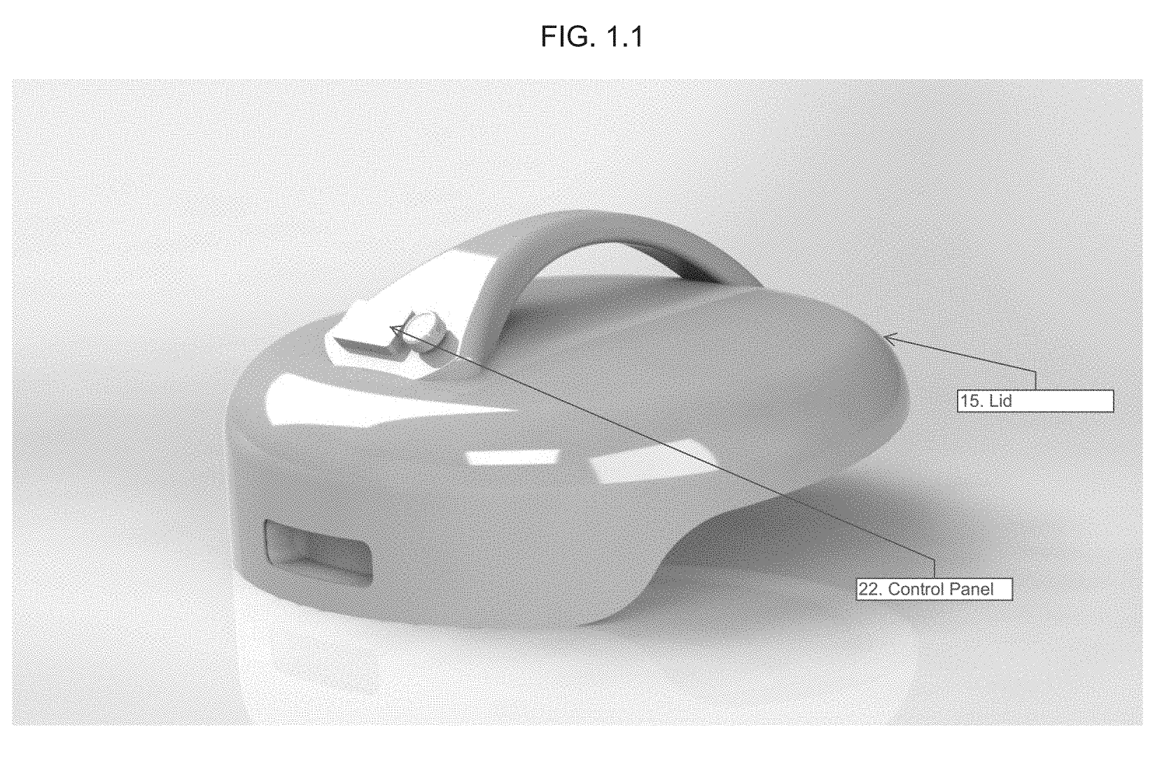

FIG. 1.0 is a perspective view of the present invention in an assembled state. Insulation and embedded charcoal 12 are housed between exterior shell 10 and interior shell 11. The inside of the cooling storage device is accessible through the lid 15 mounted to the top. The illustrated integrated cooling device mechanism 21 and cooling plates 20 are mounted inside the garbage storage device at the top and bottom in order to cool the inside of the garbage storage unit. The electrical cord and plug 24 are inserted into an electrical outlet to power the cooling device. The illustrated control panel 22 is located on the exterior of the garbage storage device, which allows the user to manually turn the device on and off, automatically turn the device on and off, and adjust the temperature inside the garbage storage device.

FIG. 1.1 is a perspective view of the lid 15 of the present invention. The illustrated control panel 22 is located on the top of the exterior part of the lid 15. The control panel 22 can have digital functionality.

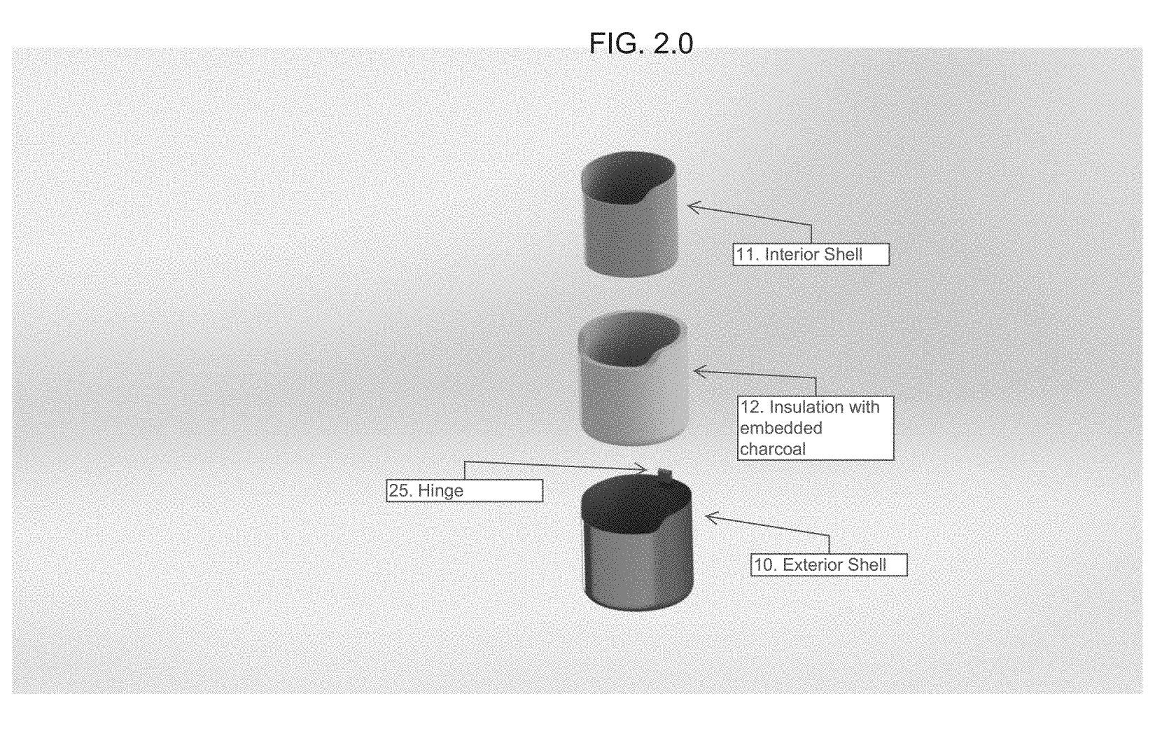

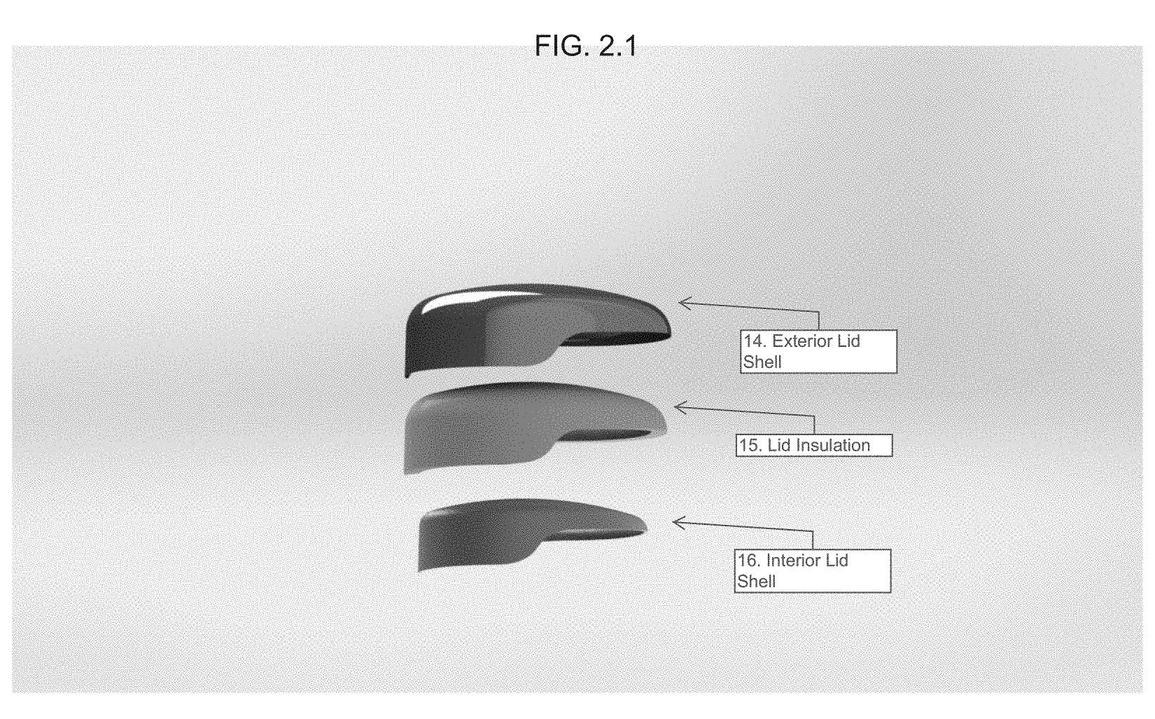

FIG. 2.0 is an exploded perspective view of the exterior shell 10 separated from the interior shell 11. Insulation with embedded carbon 12 can be housed between exterior shell 10 and interior shell 11 in order to help retain the cool air within the garbage storage device. The illustrated insulation 12 contains charcoal to reduce odor wafting from inside the garbage storage device. A hinge 25 can secure the lid to the exterior shell 10.

FIG. 2.1 is an exploded perspective view of the exterior lid shell 14 separated from both the lid insulation 15 and interior lid shell 16. Lid insulation 15 helps retain the cool air within the garbage storage device. The illustrated lid insulation 15 also contains charcoal to reduce odor wafting from inside the garbage storage device.

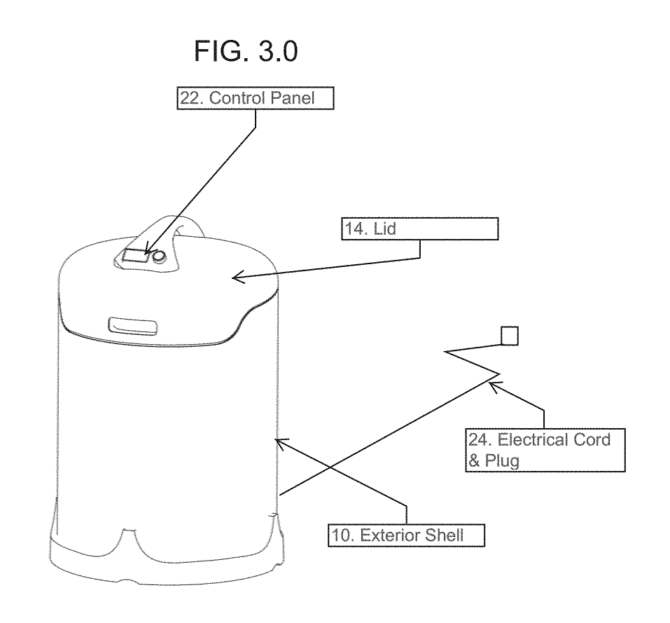

FIG. 3.0 is a schematic view of the separate exterior components of the invention.

The illustrated lid 14 is located at the top of the storage garbage device, which allows the user to access the interior of the garbage storage device. The illustrated control panel 22 is located on top of the lid 14 in order for the user to manually turn off and on, automatically turn off and on, and to adjust the temperature inside the garbage storage device. The electrical cord and plug 24 are connectable to an electrical outlet to power the cooling device 21, which cools the inside of the garbage storage device. The illustrated exterior shell 10 establishes the perimeter of the garbage storage device.

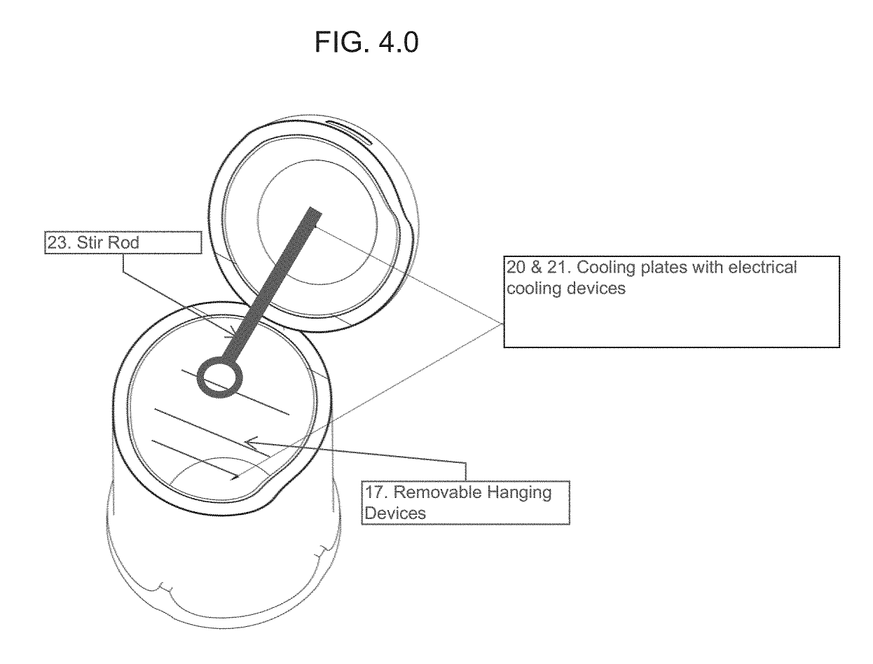

FIG. 4.0 is a schematic view of the interior of the garbage storage device. The illustrated cooling plates 20 and cooling devices 21 are integrated at the top and bottom of the interior of the garbage storage device. The illustrated embodiment includes a stir rod 23 that is integrated into the garbage storage device to assist in rotating the garbage while it is stowed inside the garbage storage device. Removable hanging devices 17 can also be integrated inside the garbage storage device in order to hang or drape garbage.

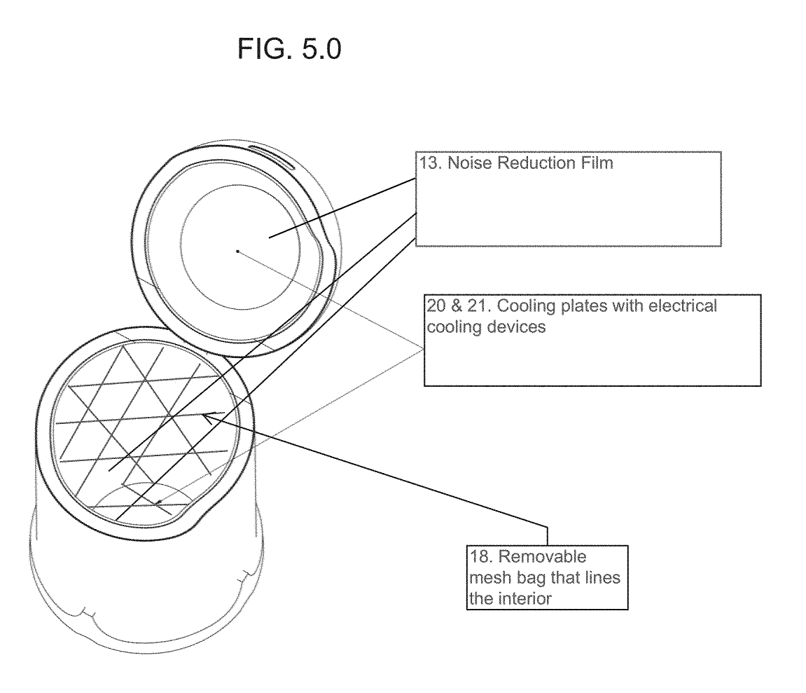

FIG. 5.0 is a schematic view of the interior of the garbage storage device. Noise reduction film 13 can be integrated around the inside lid shell 15, around the interior shell 11, and at the bottom of the garbage storage device. Noise reduction film 13 can also be integrated around the cooling plates 20 and cooling devices 21. A removable mesh bag(s) 18 can line the interior of the garbage storage device to enable the user to remove and transport garbage that is inside the garbage storage device.

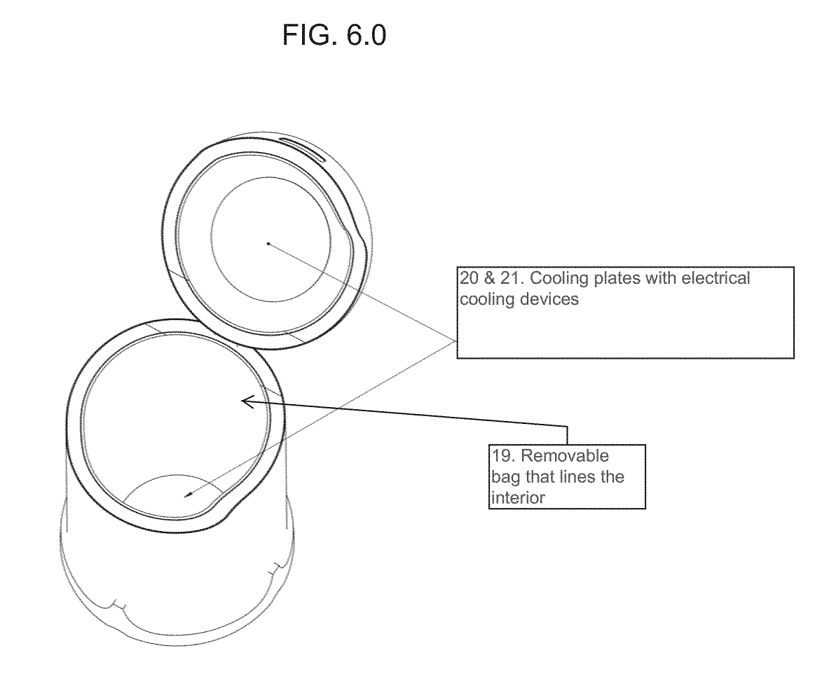

FIG. 6.0 is a schematic view of the interior of the garbage storage device. In the illustrated embodiment, a removable bag 19 lines the interior shell 15 of the garbage storage device to enable the user to remove and transport garbage that is inside the garbage storage device.

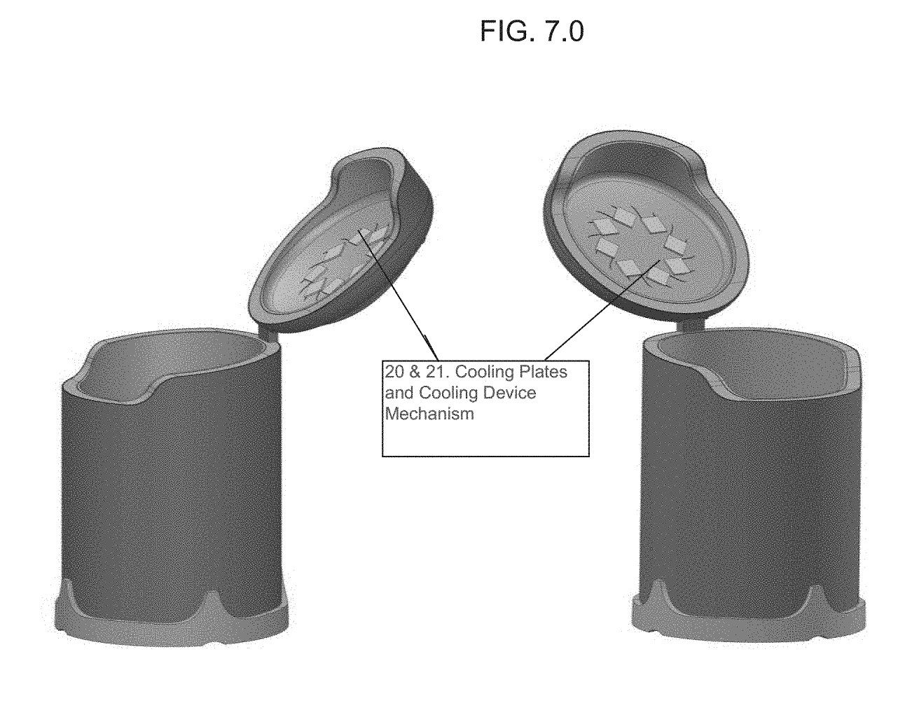

FIG. 7.0 is a schematic view of the inside lid shell 15 of the garbage storage device.

In the illustrated embodiment, cooling plates 20 and cooling device mechanisms 21 are integrated into the interior lid shell 15 and at the bottom of the interior shell 11. The illustrated cooling plates 20 and cooling device mechanism 21 generate cool air in order to cool the inside of the garbage storage unit.

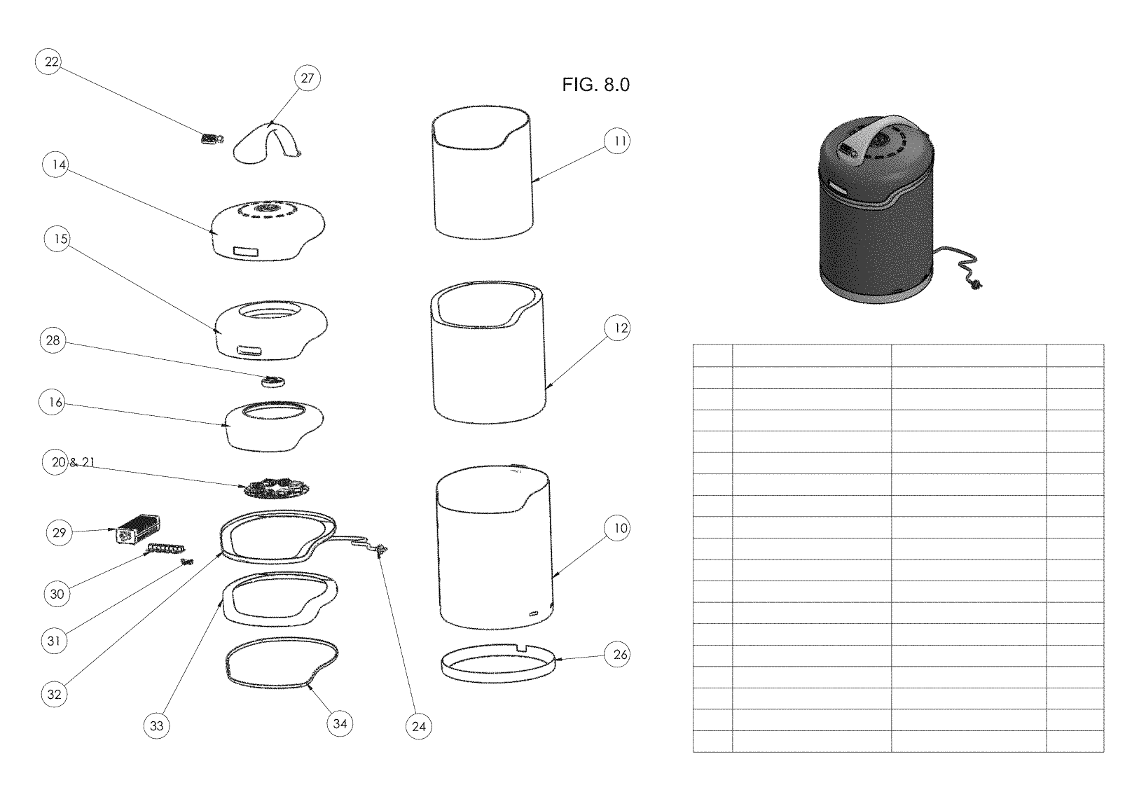

FIG. 8.0 is an exploded perspective view showing the components of the device according to some embodiments of the present invention.

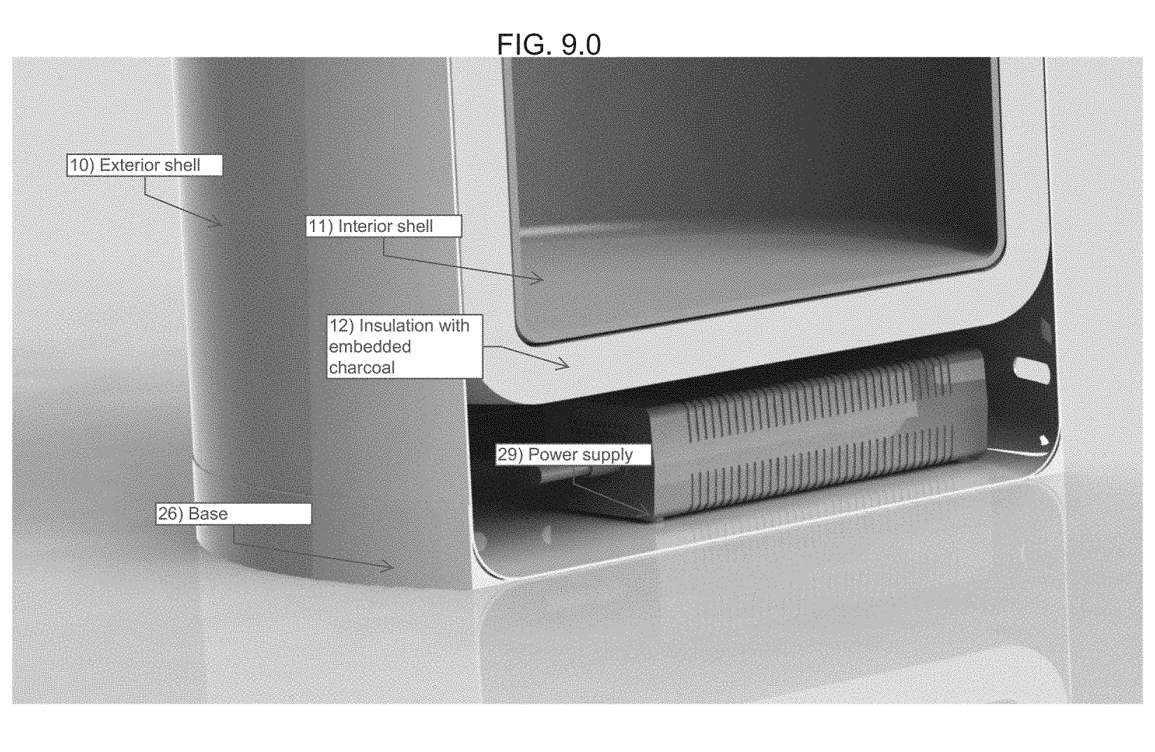

FIG. 9.0 is a cross-sectional view of components of the device according to some embodiments of the present invention. In the illustrated embodiment, a power supply 29 is integrated into the bottom base of the garbage storage device.

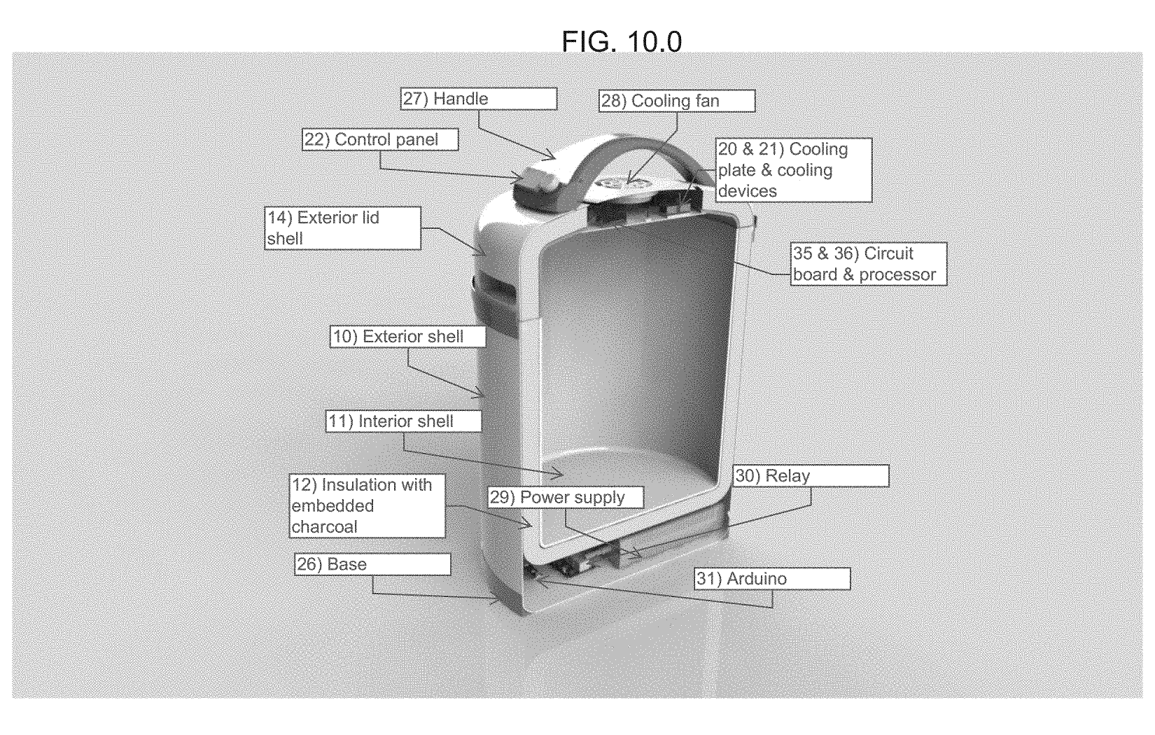

FIG. 10.0 is a cross-sectional view of components of the device according to some embodiments of the present invention. In the illustrated embodiment, cooling plates 20 and cooling device mechanisms 21 are integrated into the interior lid shell 15 and at the bottom of the interior shell 11. The illustrated cooling plates 20 and cooling device mechanism 21 generate cool air in order to cool the inside of the garbage storage unit. A power supply 29, relay 30, and arduino 31 can be integrated into the bottom base 26 of the garbage storage device. A circuit board 35 and microprocessor 36 can be integrated in between the exterior lid shell 14 and the interior lid shell 16. A control panel 22 can be integrated into the exterior lid shell 14 or handle 27.

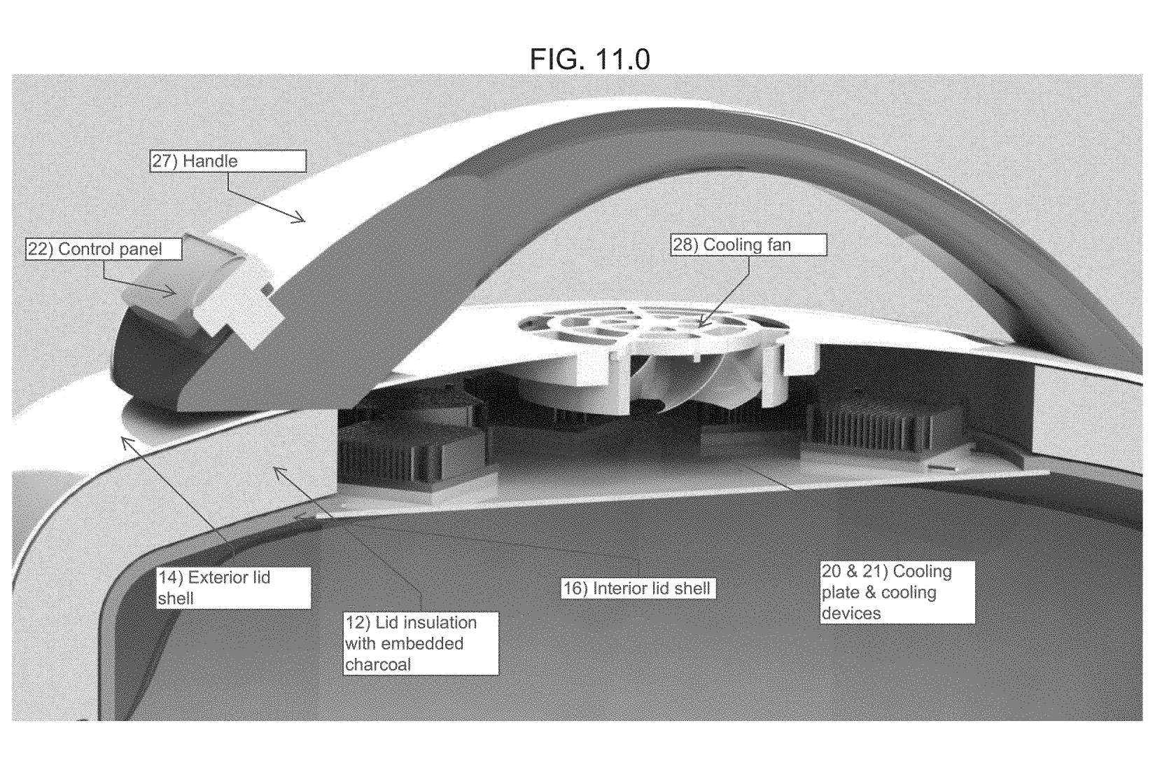

FIG. 11.0 is a cross-sectional view of components of the device according to some embodiments of the present invention. In the illustrated embodiment, a cooling fan 28 is integrated into the exterior lid shell 14. A control panel can be integrated into either the exterior lid shell 14 or handle 27. A cooling plate 20 and cooling devices 21 can be integrated between the exterior lid shell 14 and the interior lid shell 16 below the cooling fan 28.

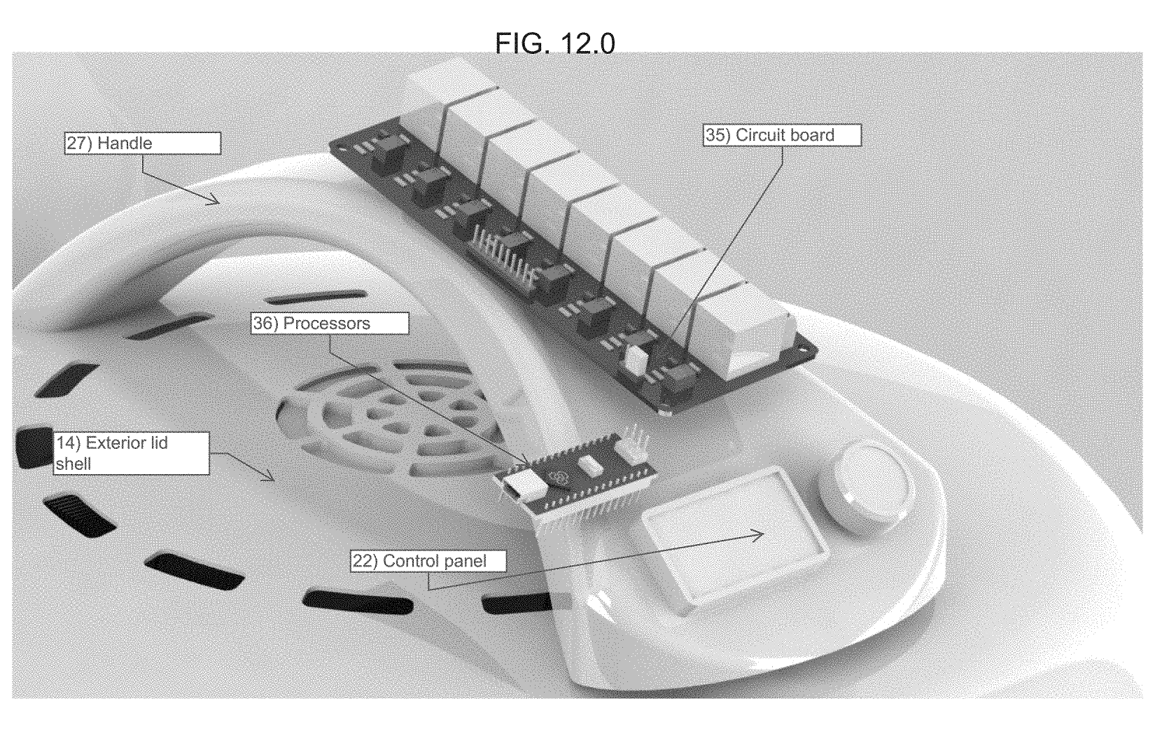

FIG. 12.0 is a perspective view, showing the circuit board and microprocessor according to some embodiments of the present invention. The illustrated circuit board and micro-processor are positioned outside of the lid. A circuit board 35 and microprocessor 36 can be integrated between the exterior lid shell 14 and the interior lid shell 16. A control panel 22 can be linked to the circuit board 35 and micro-processor 36. The control panel 22 can be integrated into the exterior lid shell 14 or the handle 27. A cooling fan 28 can be integrated into the exterior lid shell 14.

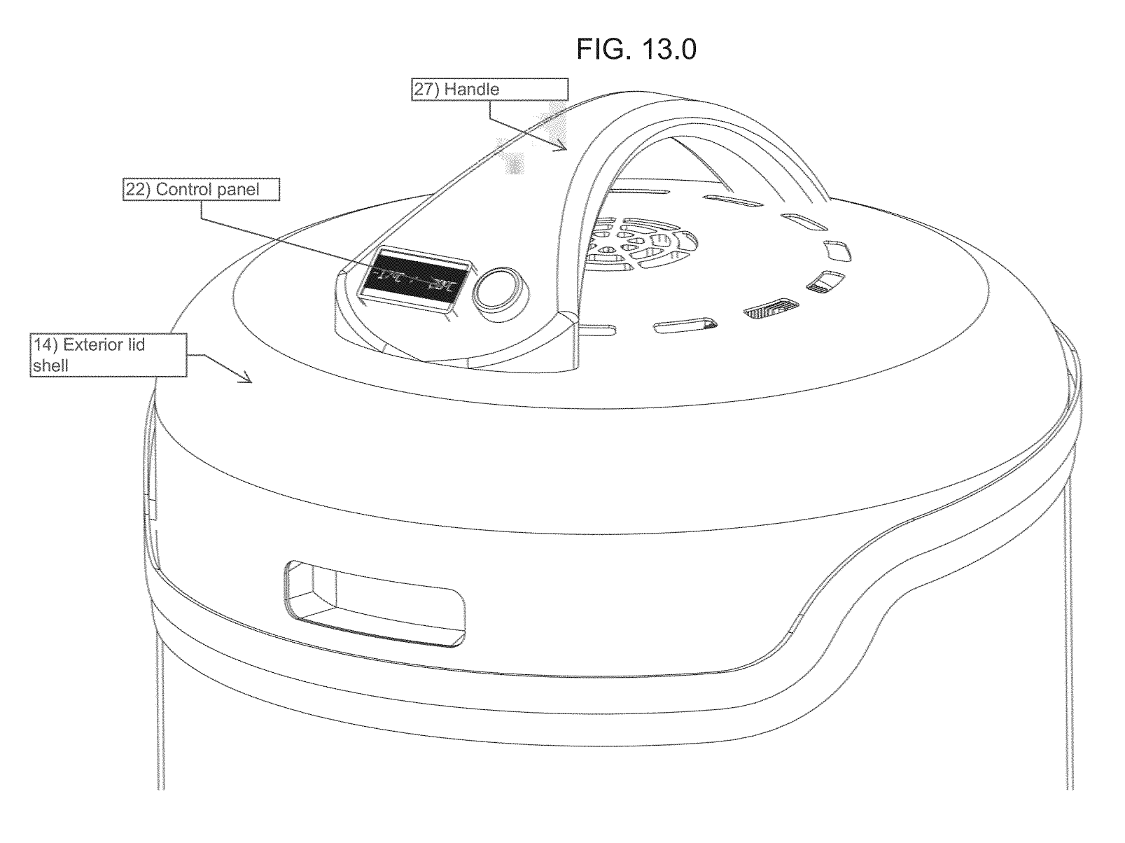

FIG. 13.0 is a schematic view, showing the exterior lid according to some embodiments of the present invention. A control panel 22 can be integrated into the exterior lid shell 14 or the handle 27. A cooling fan 28 can be integrated into the exterior lid shell 14 or handle 27.

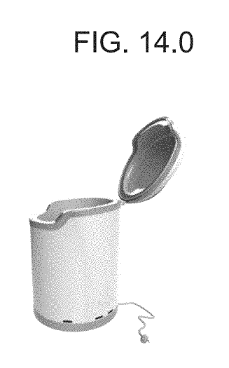

FIG. 14.0 is a perspective view of the container according to some embodiments of the present invention with the top in an open position.

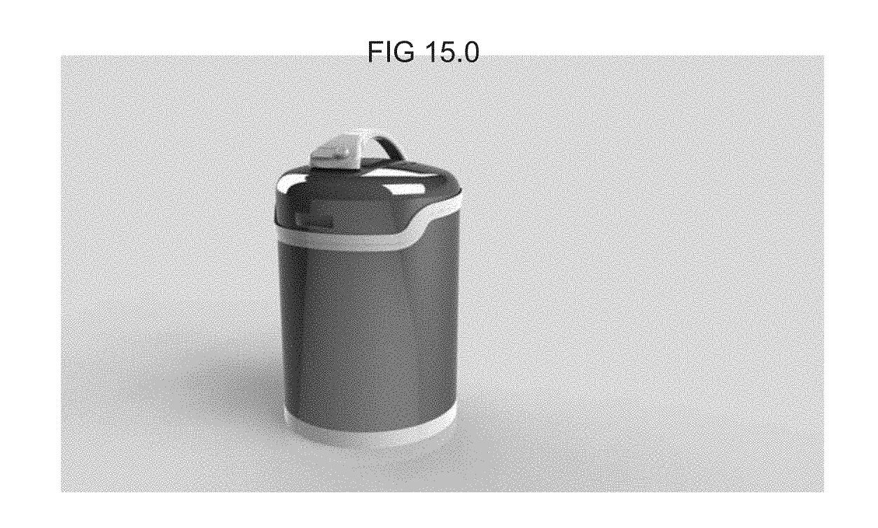

FIG. 15.0 is a perspective view of the container according to some embodiments of the present invention with the top in a closed position.

1. A garbage, trash, and waste storage container including a heat exchanger operable that when executed, perform the step of:
Reducing the temperature of the garbage, trash, and waste located in an interior of the garbage, trash, and waste storage container;
Maintaining the temperature of the garbage, trash, and waste located in an interior of the garbage, trash, and waste storage container below a pre-determined temperature.
Increasing and decreasing the temperature of the garbage, trash, and waste located in an interior of the garbage, trash, and waste storage container below and above a pre-determined temperature.
